(19) United States
(12) Patent Application Publication
(10) Pub. No.: US 2015/0379664 A1
(43) Pub. Date: Dec. 31, 2015

(54) ACCELERATED SINGLE PLANE CLIPPING OF POLYGONS IN GRAPHICS PROCESSING

(71) Applicants: KALYAN K. BHIRAVABHATLA, Bangalore (IN); PETER L. DOYLE, El Dorado Hills, CA (US); SUBRAMANIAM MAIYURAN, Gold River, CA (US)

(72) Inventors: KALYAN K. BHIRAVABHATLA, Bangalore (IN); PETER L. DOYLE, El Dorado Hills, CA (US); SUBRAMANIAM MAIYURAN, Gold River, CA (US)

(21) Appl. No.: 14/316,895

(22) Filed: Jun. 27, 2014

(51) Int. Cl. G06T 1/20; G06T 17/10

(52) U.S. Cl. CPC G06T 1/20; G06T 17/10

(57) ABSTRACT

Methods and hardware may process single plane clipping operations using a pipeline specialized for single plane clipping. A second pipeline may be provided to handle clipping in multi-clipping plane cases. By optimizing the hardware and methods around single plane clipping, polygon throughput may be enhanced.

### BACKGROUND

Graphics processing and more specifically three-dimensional (3D) rendering are often accomplished in terms of polygons such as triangles, which are sometimes referred to as primitives. As the demand for graphics performance increases in various devices such as those associate with gaming, the speed with which such primitives may be processed may be a limiting factor in various contexts, such as in integrated and handheld graphics cores in a graphics processing unit (GPU).

One technique for speeding up the processing of primitives such as triangles is to process them only when they need to be processed. If a triangle lies entirely outside a field of view for a given context—often defined by a six-sided “viewing frustum”—then it may be dispensed with without any further processing. But if the triangle overlaps a boundary of interest, it may be cut by one or more of the planes that form the viewing frustum, with the portion of the triangle that lies outside of the viewing frustum excluded from further processing in an approach known as “clipping.”

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of a viewing frustum, including an example of triangles;

FIG. 2 is an example of a triangle having barycentric coordinates;

FIG. 3 is an example of a triangle that has been cut by a plurality of clipping planes;

FIG. 4 is an example of the triangle of FIG. 3 having been cut by a single clipping plane;

FIG. 5 illustrates examples of certain variables associated with a side of a clipped triangle according to an embodiment;

FIG. 6A is an example of a triangle that has been cut by a single clipping plane, with the vertex of the triangle lying on the outside and the base lying on the inside;

FIG. 6B is an example of a triangle that has been cut by a single clipping plane, with the vertex of the triangle lying on the inside the base lying on the outside;

FIG. 7 is a flowchart of an example of a method of handling clipping operations according to an embodiment;

FIG. 8 is an example of hardware to process clipping operations according to an embodiment; and

FIG. 9 is a block diagram of an example of a system according to an embodiment.

### DESCRIPTION OF EMBODIMENTS

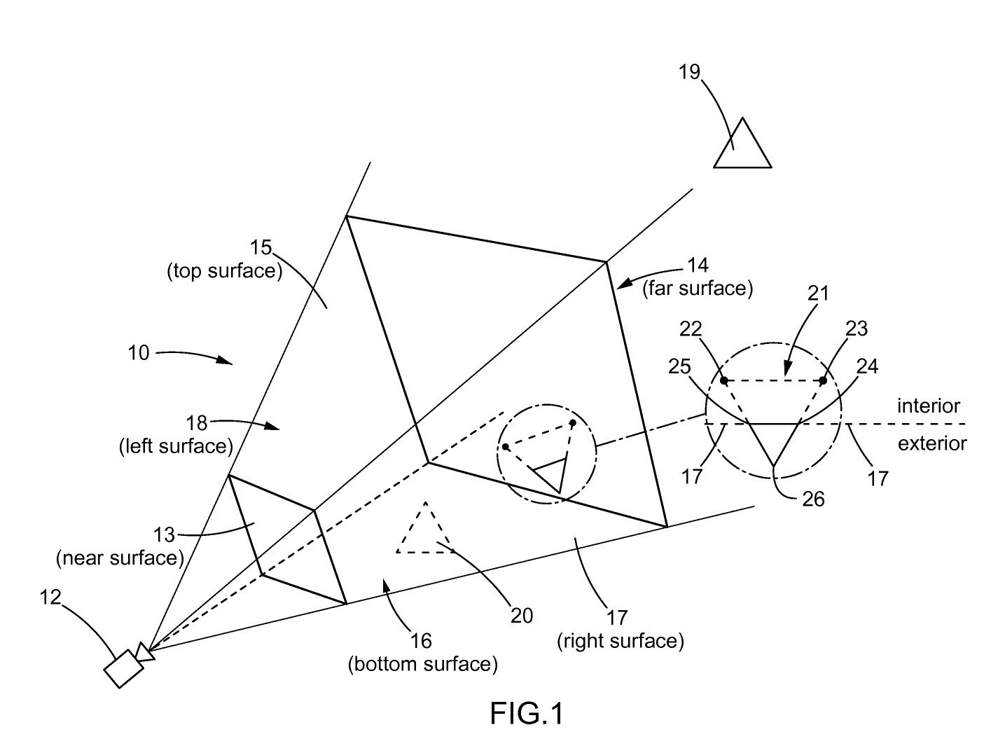

FIG. 1 illustrates a viewing frustum 10 considered from the perspective of an apex 12. The viewing frustum 10 has a near surface 13, a far surface 14, a top surface 15, a bottom surface 16, a right surface 17, and a left surface 18. Also shown in conjunction with the viewing frustum 10 are exemplary triangles 19, 20, and 21. Clipping in 3D graphics pipelines may be performed to discard portions of a scene that lie outside of the viewing frustum. As it may be wasteful to perform graphics operations on a triangle that lies entirely outside of the viewing frustum, such objects (e.g. triangle 19), are said to be “trivially rejected,” i.e., rejected for further processing. On the other hand, objects that are contained completely inside the view volume such as triangle 20 are processed, and these may be sent down the pipeline for further processing, or in other words, are trivially accepted (TA). Of concern here are objects such as triangle 21 that have vertices within the viewing frustum that are intersected by the surface of the viewing frustum, such that portions of the object lies within the viewing frustum and other portions lie outside of the viewing frustum. In the case of triangle 21 in FIG. 1, the right surface 17 of the frustum 10 acts as a clipping plane, dividing the triangle 21 into an interior polygonal portion 22-23-24-25 (which itself may be further divided into triangles 22-23-24 and 24-25-22) and an exterior or outside portion 24-25-26. Such a triangle may be clipped, generating a new triangle with new vertices at the clipping plane. The illustration of clipping in terms of the right surface 17 as is presented here is for the sake of clarity of illustration. Any of the other surfaces 13, 14, 15, 16, and 18, either alone or in combination with one another (including right surface 17) may act as clipping planes on a given triangle.

Clipping operations may be costly in terms of cycle time and other benchmarks of computer usage such as latency, throughput, and power usage, and may substantially degrade the performance of the graphics subsystem.

While as many as six viewing frustum clipping planes may intercept a general polygon, it has been determined that the distribution of clipping planes in real world applications may be very uneven and, in fact, is heavily skewed to the case of a single clipping plane. In the vast majority of cases where clipping arises, only a single clipping plane is involved.

Although other kinds of polygons are capable of use in graphics, these may generally be reduced to triangle primitive form, and thus the examples that follow are presented in terms of triangles. However, the embodiments are capable of use with other polygons, such as rectangles, pentagons, hexagons etc.

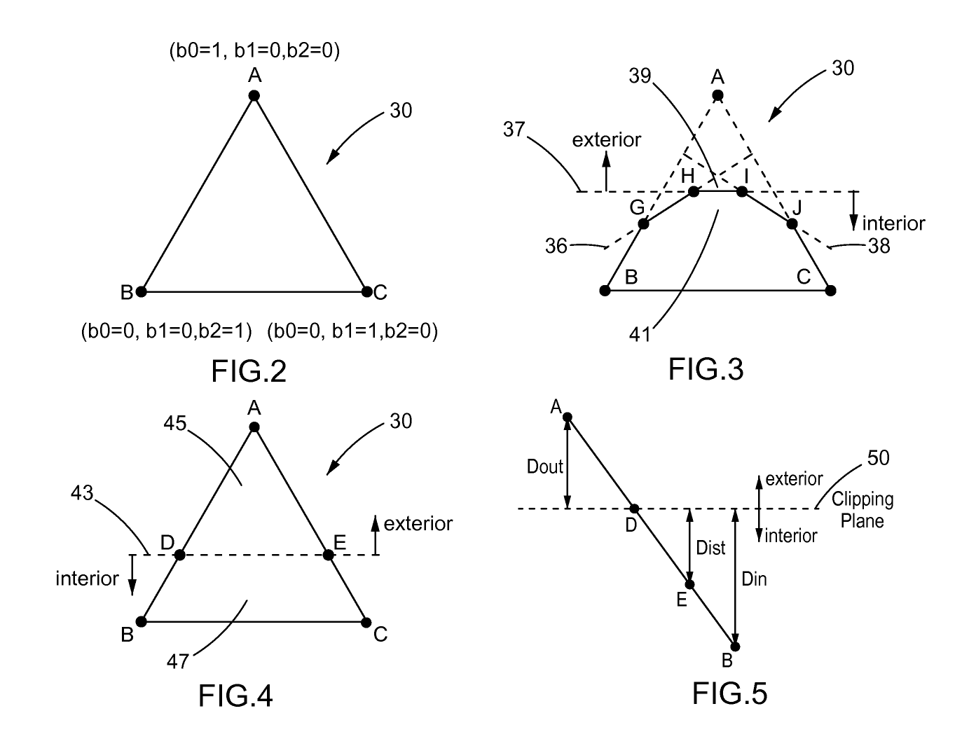

FIG. 2 shows an exemplary triangle 30 having vertices A, B, and C, which may have a variety of attributes such as color values (e.g., red, green, and blue intensities), transparency, texture, and location. In the embodiments described here, these values may be expressed in barycentric coordinate form. In the case of triangle 30, each vertex has attributes b0, b1, and b2, which as noted above, may indicate color values, texture, intensities, or any other attribute of interest. There may be fewer or more such attributes, but in the examples that follow, three attributes (b0, b1, and b2) are depicted for illustrative purposes.

FIG. 3 shows the triangle 30 after it has been cut by three clipping planes 36, 37, and 38, producing an exterior portion 39 and an interior portion 41. It is noted that clipping a triangle with any number of planes will result in a convex polygon, here B-G-H-I-J-C, which forms a boundary between an excluded exterior portion 39 and an interior portion 41. As noted above, the outside or exterior region is excluded in the sense that it lies outside the viewing frustum and thus need not be further processed (i.e., it is “clipped”), whereas the included interior portion 41 may generally require further graphics processing. Polygon B-G-H-I-J-C may be broken down into triangles B-G-H, B-H-I, B-I-J, and B-J-C, or four triangles for the one with which the process began. It is further noted that where there were initially just three vertices with barycentric coordinates and these were known, there now are six, four of which must be calculated (the barycentric coordinates of points B and C are unchanged). This may be a computationally time consuming task.

FIG. 4 shows a simpler case, in which triangle 30 has been intercepted by a single clipping plane 43. In this case, region 45 is excluded and region 47 is included. The boundary between the regions is the line of the clipping plane 43, which defines an included interior polygon B-D-E-C. This polygon may be broken down into two triangles: B-D-E and B-E-C (or B-D-C and D-E-C). In this single clipping plane case, the system may find the value of the barycentric coordinates for the points at which the single clipping plane 43 intercepts the triangle, which in the figure are points D and E.

However many the clipping planes, for each edge of a triangle at which the clipping plane intercepts the triangle, there is a point of intersection, and barycentric values for that point may be computed. This may be done using the clip distance of the two vertices of the edge, as the distance to the clipping plane changes in a linear manner along the edge. Such an approach is illustrated in terms of FIG. 5, which shows an exemplary edge A-B that has been intercepted by a clipping plane 50. In the illustrated example, vertex A is an exterior point located outside the viewing frustum and vertex B is an interior point located inside the view frustum. The following analysis is general, in that it may be applied to a single clipping plane as well as to arbitrarily many clipping planes by taking each in sequence.

First, a number of variables are defined:
Dout: the distance from vertex A to the clipping plane 50.
Din: the distance from vertex B to the clipping plane 50.
D: the point along A-B at which it is intercepted by the clipping plane 50. alpha:
   Furthermore, in this example the distance along A-B is normalized to 1 for computational convenience.

Dist=Din*alpha+Dout*(1−alpha)

In FIG. 5, Dist is shown as the distance from an arbitrary point E located along A-B to the clipping plane 50. Setting Dist=0 (which graphically corresponds to moving point E to point D) and solving for alpha results in the value of alpha at the clipping plane. alpha=−Dout/(Din−Dout) or alpha=Dout/(Dout−Din) (It is noted that Din and Dout may be distances with which are associated signed magnitudes. Thus, if Din is positive then Dout may be negative, and Din will not equal Dout, so that division by zero is precluded.) Let beta be defined as equal to 1−alpha, reducing equations to a*x+b*y form:

beta=1−alpha=1−(Dout/(Dout−Din)=((Dout−Din)−Dout)/(Dout−Din)

beta=−Din/(Dout−Din)

Once alpha and beta have been calculated from the clipped edge, the remaining plane distances and barycentric terms are interpolated for the new vertex that arises at the point of intersection of the clipping plane and the edge.

alpha=D(B)/(D(B)−D(A)) (eqn. 1)

beta=−D(A)/(D(B)−D(A)) (eqn. 2)

b0(D)=b0(A)*alpha+b0(B)*beta (eqn. 3)

b1(D)=b1(A)*alpha+b1(B)*beta (eqn. 4)

b2(D)=b2(A)*alpha+b2(B)*beta (eqn. 5)

The final barycentric coordinates are calculated for all the new vertices, and at the end of the clipping operation new positions and attributes may be calculated as follows:

P(D)=V(A)*b0(D)+V(B)*b1(D)+V(C)*b2(D) (eqn. 6)

where V(A), V(B), and V(C) represent the original vertex attribute values at vertices A, B, and C respectively, P(D) represents the attribute (e.g. color, texture) at the new vertex D, and b0(D), b1(D) and b2(D) are the calculated barycentric values at the new vertex D.

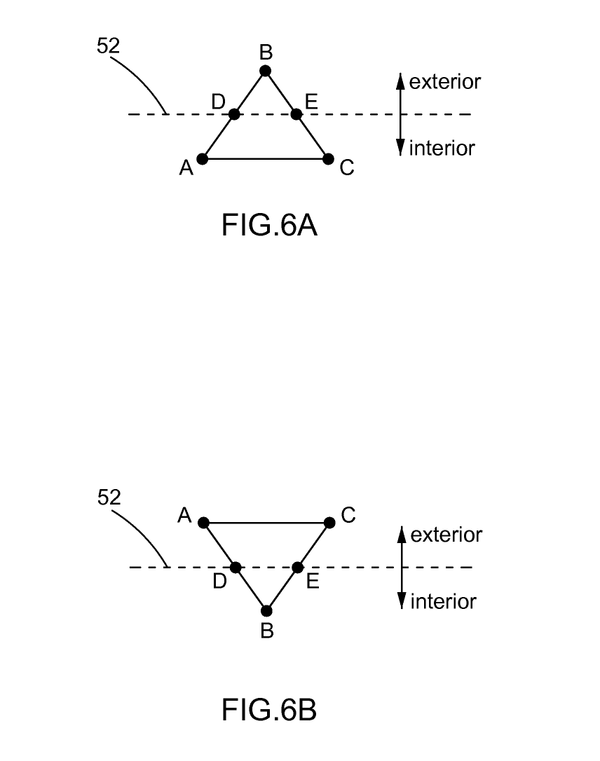

For single plane clipping one may utilize the fact that there are two possible outcomes when clipping with a single plane. FIGS. 6A and 6B illustrate these two topologies. Each topology demonstrates a single clipping plane 52 intercepting the triangle. In the topology of FIG. 6A, the triangle has its vertex B on the exterior and in the topology of FIG. 6B the vertex B is located on the interior side of the clipping plane 52.

In the case where there is only one clipping plane, one may use preceding equations 1-6 for clipping and computing initial barycentric values and the new barycentric coordinates are a simple combination of alpha and beta.

In this example, the initial barycentric values given for the vertex positions for the triangle of FIG. 2 may be used, yielding:

b0(A)=1,b1(A)=0,b2(A)=0

b0(B)=0,b1(B)=0,b2(B)=1

b0(C)=0,b1(C)=1,b2(C)=0

By substituting initial barycentric values into equations (3), (4), and (5), for the single clipping plane case the barycentric coordinates for new point D may now be evaluated as follows:

b0(D)=1*alpha+0*beta=alpha (eqn. 7)

b1(D)=0*alpha+0*beta=0 (eqn. 8)

b2(D)=0+beta=beta (eqn. 9)

The barycentric values for point E may similarly be evaluated.

It is apparent that the calculations for the single plane clipping operation are computationally less involved than those for multiple plane clipping. The operation may thus be performed using relatively fewer processor and memory resources.

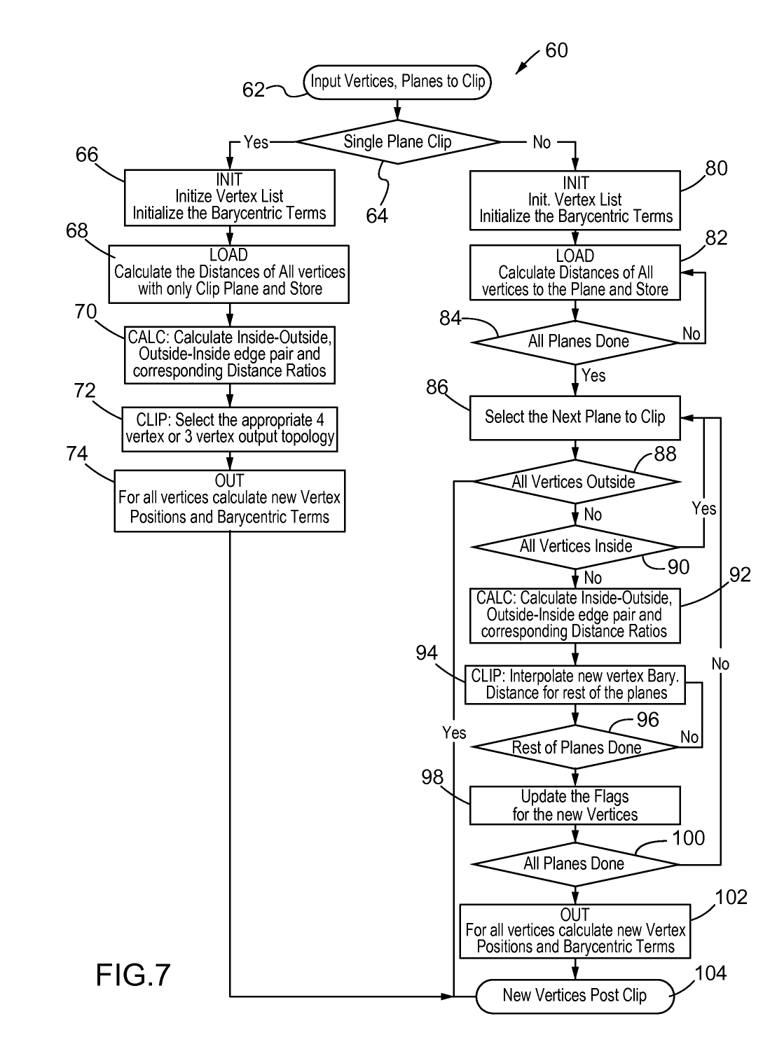

Turning now to FIG. 7, a flowchart of one example of a method of processing both single plane clipping operations and multiple plane clipping operations is shown. The method may be implemented in fixed-functionality logic hardware using circuit technology such as, for example, application specific integrated circuit (ASIC), complementary metal oxide semiconductor (CMOS) or transistor-transistor logic (TTL) technology, or any combination thereof.

At illustrated block 62 the vertices of a given input triangle are inputted, along with the clipping planes with which to perform clipping operations. Illustrated conditional block 64 tests for the number of clipping planes. If there is a single clipping plane, control passes to the left hand half of the flow chart, whereas if there are more than one clipping plane, control moves to the right hand half of the flow chart. First considered is the single clipping plane case addressed by the left hand half of the flowchart.

At illustrated block 66, the vertices of the triangle are initialized and listed, and the barycentric terms are initialized as well (i.e., normalized to 0 or 1). Then, at illustrated block 68 (e.g., the “LOAD” block), the distances of the vertices from the one clipping plane are calculated and stored. At block 70, the inside-outside, outside-inside distances ratios, i.e., alpha and beta as discussed above, are computed (as, for example, per equations 7, 8, and 9). Next, at illustrated block 72, the appropriate 4-vertex or 3-vertex output topology is selected depending on the input topology. At illustrated block 74, for all of the vertices of this topology the barycentric values at the new clipped position are calculated (as is discussed with respect to equations 7, 8 and 9), and at block 104 variable values of interest for the new vertices that result from the clipping operation are available (as, for example, through the application of eqn. 6 above).

Next considered is the case where there are multiple clipping planes. Although as noted above, in the strong majority of cases where clipping must be undertaken there is only one clipping plane, there will still be cases where multiple clipping planes must be taken into account and an embodiment of a method for this is presented in the right hand half of the flow chart. At illustrated block 80, the vertices of the triangle are initialized and listed, and the barycentric terms are initialized as well. Then, at illustrated block 82, the load block, the distances of the vertices from the particular clipping plane under consideration are calculated and stored. At block 84, it may be determined whether all of the clipping planes have been considered with respect to the preceding steps and if not, control loops back to the preceding block and once again, the distances of the vertices from the particular clipping plane under consideration are calculated and stored. If this phase of the method has been completed with respect to all clipping planes, then at block 86 commences the steps for clipping with respect to a particular plane.

At illustrated block 88 it is determined whether all of the vertices of the given triangle lie outside of the viewing frustum and if they do, the triangles are dispensed with (i.e., trivially excluded) and control passes to block 104. If not all of the vertices are outside, the method determines at block 90 whether all of the vertices are on the inside (i.e., the interior) of the viewing frustum. If so, there is no actual clipping to be done on this triangle, and control passes to block 86 for selection of the next plane to consider. If not all vertices are inside the viewing frustum, then at 92 block the inside-outside, outside-inside distances ratios, i.e., alpha and beta as discussed above are calculated, and at block 94 the method interpolates the new vertex barycentric, distance and other coordinates for the points along the edges of the triangle that have been intercepted by the clipping plane.

At block 96 may be determined whether all of the planes have been clipped against and if not, control passes back to illustrated block 94. If all have been taken into account, then block 98 flags for the new vertices may be updated and computed. The flags may be used to indicate the topology (i.e., inside versus outside) of the vertices with respect to the planes that are clipped against. At illustrated block 100, the method determines whether all of the planes have been considered and if not, control loops back to block 86. If, on the other hand, all clipping planes have been taken into account, then at block 102 new vertex positions, values and barycentric terms may be calculated for all new vertices generated, wherein the calculated positions, values and terms become available at illustrated block 104.

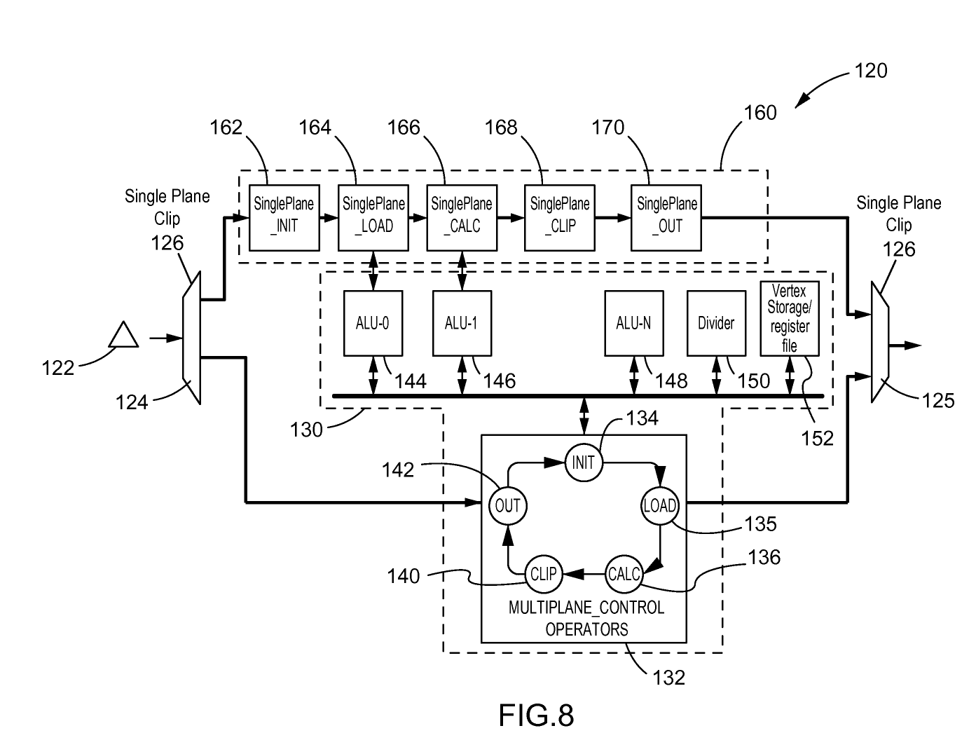

FIG. 8 illustrates an example of implementation hardware 120 with which an embodiment of the method may be practiced. In broad terms, the illustrated embodiment presents two pipelines corresponding generally to the two sides of the flow chart presented in FIG. 7, with the pipeline 160 corresponding to the left hand side of FIG. 7 and the pipeline 130 corresponding generally to the right hand half of FIG. 7. Using the implementation hardware 120 to accelerate geometry processing may improve the performance of the geometry subsystem, particularly when used in conjunction with the single plane clipping techniques described herein.

Triangles 122 may arrive at a decoder 124, which is governed by a single clip control signal 126 that informs the decoder 124 whether this triangle is subject to single plane clipping or to clipping by multiple planes. At the opposite end of the figure, this same control signal 126 may be used by multiplexer 125 to set the output.

First considered is the case where it has been determined that there are multiple clipping planes. In this implementation, there are a number of ALU resources 144, 146, and 148 (there may be more or fewer) that may implement simple A*X+B*Y sorts of linear operations, and also a divider block 150 and a register file 152 that may store the input, output, and temporary vertices that get generated during clipping operations. This implementation also contains a control block 132 to schedule the multi clip operations over these resources. This control block 132 may operate over five phases through respective modules, namely INIT module 134, LOAD module 135, CALC module 136, CLIP module 140 and OUT module 142. In the INIT phase, vertices are loaded into the register file and vertex list and barycentric values are assigned to the vertices. In the illustrated LOAD phase, ALU resources are used to calculate the distance of the vertices from the selected plane, and this process is iterated for all the enabled clipping planes. Then the calculated distances may be examined to see which planes need to be clipped against. In the CALC phase for the selected clipping plane, the illustrated hardware uses the ALU resources and the divider block to calculate the inside-outside and outside-inside distance rations (e.g., alpha, beta as per equations 1 and 2).

The illustrated CLIP evaluates the barycentric values at the new clipped position as is provided for in equations 3, 4, and 5. After this, it may be determined if another plane still needs to be clipped against.

The preceding process may be repeated iteratively until there are no planes left to be clipped against. In the OUT phase, all of the new vertex barycentric values may be read from the registers files, and the ALU resources are used again to calculate new positions and other values of interest (e.g., color, texture, etc.) by evaluating equation 6. This new evaluation may be done for all the newly generated vertices. While multi-clipping plane operations are ongoing, most of the ALUs and other resources may be engaged in the aforementioned phases, so that only one triangle will be scheduled for processing in the pipeline 130 until final outputs for it have been generated.

As has been noted above, in most instances there will be only a single clipping plane, in which case a separate pipeline 160, optimized for single clipping plane operations, is employed. In contrast to the pipeline 130 for the multiple clipping planes case, the illustrated pipeline 160 is able to handle multiple objects in the same pipeline. In the case of a single plane clipping operation, each ALU resource may be tied to one phase and that ALU may be only used for that operation, which permits the processing of multiple triangles in the pipeline. In the illustrated embodiment, five triangles may be processed in the pipeline 160. This approach is in contrast to the case of the multiple plane clipping (pipeline 130) where each ALU will generally be shared for multiple operations involving more numerous calculations for multiple lanes. In that case, as a practical matter the computational demands are such that only one triangle may be processed at a time.

In the SinglePlane_INIT module 162, vertices are loaded and barycentric values are assigned to the vertices. In the SinglePlane_LOAD module 164, one ALU resource 144 is used to calculate the distance of the vertices from the single plane that is being clipped against, so it need not evaluate distances from multiple clipping planes. In the SinglePlane_CALC module 166 for the selected clipping plane, another ALU resource 146 is used along with the divider block 150 to calculate the inside-outside and outside-inside distance ratios (i.e. alpha, and beta as discussed above with respect to equations 1 and 2). In the SinglePlane_CLIP module 168 the new barycentric values are evaluated by assigning alpha and beta values as has been demonstrated in equations 7,8 and 9 above. The input topology may determine whether one or two new vertices need to be generated. In the illustrated SinglePlane_OUT module 170, another ALU resource (not shown) is used to evaluate the final position or other desired value (e.g. color, texture, etc.) by performing a calculation as is presented in equation 6.

The following table shows an example of the throughput of the “must clip” clipping operations of the single and multi-plane cases:

| | Clock cycles without | Clock cycles with |
|---|---|---|
| “Must clip” case | single plane pipeline | single plane pipeline |
| Single clipping plane | S + M | SP_M |
| N-clipping planes | S + N*M | S + N*M |

where:
S=number of fixed cycles spent on initial setup and final output and all other book keeping operations;
N=number of planes being clipped against;
M=cycles spent on clipping against each plane;
SP_M the worst-case stage latency of single plane clipping operation.
It is noted that the SP_M latency will generally be substantially lower than M and indeed be close to the ALU latency.

Substantial performance gains may be achieved through the implementation of embodiments disclosed herein. For most workloads, single plane implementation such as is disclosed herein may yield good performance gains. Moreover, removing even half of the ALUs may have little performance impact, which means that there also may be an area benefit, in that fewer transistors or gates may be used in the design, thus saving on overall chip area and cost. Thus, there may be both a performance and an area benefit in implementing a separate pipeline for single plane hardware clipping such as is described here.

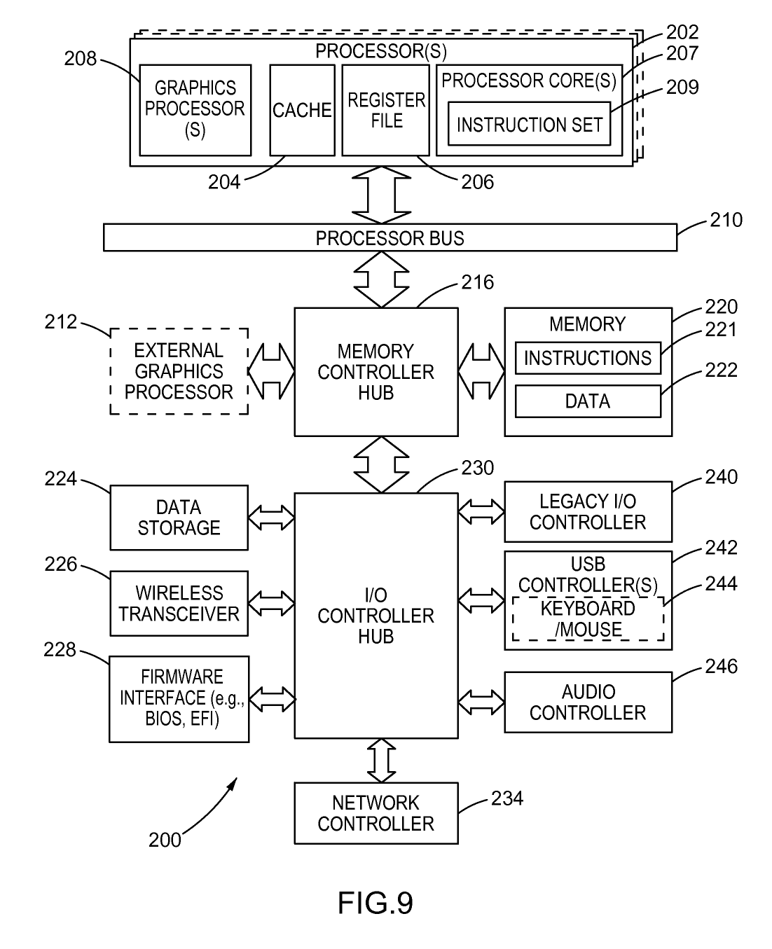

FIG. 9 is a block diagram of a data processing system 200, according to an embodiment. The data processing system 200 includes one or more processors 202 and one or more graphics processors 208, and may be a single processor desktop system, a multiprocessor workstation system, or a server system having a large number of processors 202 or processor cores 207. The embodiments disclosed herein may be part of one or more of the graphics processors 208. In on embodiment, the data processing system 200 is a system on a chip integrated circuit (SOC) for use in mobile, handheld, or embedded devices.

An embodiment of the data processing system 200 can include, or be incorporated within a server-based gaming platform, a game console, including a game and media console, a mobile gaming console, a handheld game console, or an online game console. In one embodiment, the data processing system 200 is a mobile phone, smart phone, tablet computing device or mobile Internet device. The data processing system 200 can also include, couple with, or be integrated within a wearable device, such as a smart watch wearable device, smart eyewear device, augmented reality device, or virtual reality device. In one embodiment, the data processing system 200 is a television or set top box device having one or more processors 202 and a graphical interface generated by one or more graphics processors 208.

The one or more processors 202 each include one or more processor cores 207 to process instructions which, when executed, perform operations for system and user software. In one embodiment, each of the one or more processor cores 207 is configured to process a specific instruction set 209. The instruction set 209 may facilitate complex instruction set computing (CISC), reduced instruction set computing (RISC), or computing via a very long instruction word (VLIW). Multiple processor cores 207 may each process a different instruction set 209 which may include instructions to facilitate the emulation of other instruction sets. A processor core 207 may also include other processing devices, such a digital signal processor (DSP).

In one embodiment, the processor 202 includes cache memory 204. Depending on the architecture, the processor 202 can have a single internal cache or multiple levels of internal cache. In one embodiment, the cache memory is shared among various components of the processor 202. In one embodiment, the processor 202 also uses an external cache (e.g., a Level 3 (L3) cache or last level cache (LLC)) (not shown) which may be shared among the processor cores 207 using known cache coherency techniques. A register file 206 is additionally included in the processor 202 which may include different types of registers for storing different types of data (e.g., integer registers, floating point registers, status registers, and an instruction pointer register). Some registers may be general-purpose registers, while other registers may be specific to the design of the processor 202.

The processor 202 is coupled to a processor bus 210 to transmit data signals between the processor 202 and other components in the system 200. The system 200 uses an exemplary ‘hub’ system architecture, including a memory controller hub 216 and an input output (I/O) controller hub 230. The memory controller hub 216 facilitates communication between a memory device and other components of the system 200, while the I/O controller hub (ICH) 230 provides connections to I/O devices via a local I/O bus.

The memory device 220, can be a dynamic random access memory (DRAM) device, a static random access memory (SRAM) device, flash memory device, or some other memory device having suitable performance to serve as process memory. The memory 220 can store data 222 and instructions 221 for use when the processor 202 executes a process. The memory controller hub 216 also couples with an optional external graphics processor 212, which may communicate with the one or more graphics processors 108 in the processors 202 to perform graphics and media operations.

The ICH 230 enables peripherals to connect to the memory 220 and processor 202 via a high-speed I/O bus. The I/O peripherals include an audio controller 246, a firmware interface 228, a wireless transceiver 226 (e.g., Wi-Fi, Bluetooth), a data storage device 224 (e.g., hard disk drive, flash memory, etc.), and a legacy I/O controller for coupling legacy (e.g., Personal System 2 (PS/2)) devices to the system. One or more Universal Serial Bus (USB) controllers 242 connect input devices, such as keyboard and mouse 244 combinations. A network controller 234 may also couple to the ICH 230. In one embodiment, a high-performance network controller (not shown) couples to the processor bus 210.

The graphics and/or video processing techniques described herein may be implemented in various hardware architectures. For example, graphics and/or video functionality may be integrated within a chipset. Alternatively, a discrete graphics and/or video processor may be used. According to still another embodiment, the graphics and/or video functions may be implemented by a general purpose processor, including a multi-core processor. In a further embodiment, the functions may be implemented in a consumer electronics device.

### Additional Notes and Examples

Example 1 may include a method of processing at least one graphics polygon, comprising determining a number of clipping planes against which a polygon is to be clipped and submitting, if there is only a single clipping plane, the polygon to a pipeline dedicated to single plane clipping.

Example 2 may include the method of Example 1, further including loading coordinates of vertices of the polygon and assigning barycentric values to the vertices.

Example 3 may include the method of Example 2, further including calculating a distance of the single clipping plane to each of the vertices.

Example 4 may include the method of Example 3, further including calculating distance ratios alpha and beta, wherein alpha=Dout/(Din−Dout), wherein Dout is the distance from one vertex to the clipping plane and Din is the distance from an adjacent vertex to the clipping plane, and beta=1−alpha.

Example 5 may include the method of Example 4, further including normalizing the distance between adjacent vertices.

Example 6 may include the methods of Examples 1-5, further including assigning new barycentric values to points that lie at an intersection of the determined clipping plane and the polygon.

Example 7 may include the methods of Examples 1-5, further including assigning new values to points that lie at an intersection of the determined clipping plane and the polygon.

Example 8 may include the methods of Examples 1-5, wherein the polygon is a triangle.

Example 9 may include the method of Example 1, further including submitting, if there is more than one clipping plane, the polygon to a second pipeline dedicated to multi-plane clipping.

Example 10 may include an apparatus to process at least one graphics polygon, comprising a module that determines a number of clipping planes against which a polygon is to be clipped, and a pipeline dedicated to single plane clipping.

Example 11 may include the apparatus of Example 10, further including a module to load coordinates of vertices of the polygon, and assign barycentric values to the coordinates of the vertices.

Example 12 may include the apparatus of Example 11, further including a module to calculate the distance of a single clipping plane to each of the vertices.

Example 13 may include the apparatus of Examples 10-12, further including a module to calculate distance ratios alpha and beta, wherein alpha=Dout/(Din−Dout), wherein Dout is the distance from one vertex to the clipping plane and Din is the distance from an adjacent vertex to the clipping plane, and beta=1−alpha.

Example 14 may include the apparatus of Examples 10-12, further including a module to normalize the distance between adjacent vertices.

Example 15 may include the apparatus of Example 13, further including a module to assign new barycentric values to points that lie at an intersection of the determined clipping plane and the polygon.

Example 16 may include the apparatus of Examples 13, further including a module to assign new values to points that lie at the intersection of the determined clipping plane and the polygon.

Example 17 may include the apparatus of Example 11, wherein the polygon is a triangle.

Example 18 may include the apparatus of Example 11, further comprising a second pipeline to handle cases in which there is more than one clipping plane.

Example 19 may include the apparatus of Example 18, wherein the modules are available to both pipelines.

Example 20 may include a system to process at least one graphics polygon, comprising a graphics processing unit; a module that determines a number of clipping planes against which a polygon is to be clipped; a first pipeline dedicated to single plane clipping; and a second pipeline dedicated to multi-plane clipping.

Example 21 may include the system of Example 20, further including a module associated with the first pipeline to load coordinates of vertices of the polygon, and assign barycentric values to the vertices.

Example 22 may include the system of Example 21, further including a module associated with the first pipeline to calculate a distance of the single clipping plane to each of the vertices.

Example 23 may include the system of Example 22, further including a module associated with the first pipeline to calculate distance ratios alpha and beta, wherein alpha=Dout/(Din−Dout), wherein Dout is the distance from one vertex to the clipping plane and Din is the distance from an adjacent vertex to the clipping plane, and beta=1−alpha.

Example 24 may include the system of Examples 21-23, further including a module associated with the first pipeline to assign new barycentric values to points that lie at an intersection of the determined clipping plane and the polygon.

Example 25 may include the system of Example 24, further including a module associated with the first pipeline to assign new values to points that lie at the intersection of the determined clipping plane and the polygon.

Example 26 may include an apparatus to process at least one graphics polygon, comprising means to determine a number of clipping planes against which a polygon is to be clipped, and a pipeline dedicated to single plane clipping.

Example 27 may include the apparatus of Example 26, further including means to load coordinates of vertices of the polygon and to assign barycentric values to the coordinates of the vertices.

Example 28 may include the apparatus of Example 27, further including means to calculate the distance of the single clipping plane to each of the vertices.

Example 29 may include the apparatus of Examples 26-28, further including means to calculate distance ratios alpha and beta, wherein alpha=Dout/(Din−Dout), wherein Dout is the distance from one vertex to the clipping plane and Din is the distance from an adjacent vertex to the clipping plane, and beta=1−alpha.

Example 30 may include the apparatus of Examples 26-28, further including means to assign new barycentric values to points that lie at the intersection of the determined clipping plane and the polygon.

Example 31 may include the apparatus of Examples 26-28, further including means to assign new values to points that lie at the intersection of the determined clipping plane and the polygon.

Example 32 may include the apparatus of Examples 30, wherein the values are reflective of one or more of a color value, a texture, or an intensity.

Example 33 may include the apparatus of Example 26, wherein the polygon is a triangle.

Example 34 may include the apparatus of Examples 26-28, further comprising a second pipeline to handle cases in which there is more than one clipping plane.

Example 35 may include an apparatus for clipping polygons in graphics rendering comprising: a first pipeline to be used in case of a single clipping plane; and a second pipeline to be used in case of more than one clipping plane, wherein polygons that are to be clipped with a single clipping plane are sent to the first pipeline and all other polygons are sent to the second pipeline.

Example 36 may include the apparatus of Example 35, wherein the two pipelines share arithmetic logic units.

Various embodiments or elements of embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments may be practiced without, or with variation of, these specific details. The description is thus to be regarded as illustrative instead of limiting.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A system to process at least one graphics polygon, comprising:
a graphics processing unit;
a module that determines a number of clipping planes against which a polygon is to be clipped;
a first pipeline dedicated to single plane clipping; and
a second pipeline dedicated to multi-plane clipping.

2. The system of claim 1, further including a module associated with the first pipeline to:
load coordinates of vertices of the polygon; and
assign barycentric values to the coordinates of the vertices.

3. The system of claim 2, further including a module associated with the first pipeline to calculate a distance of the single clipping plane to each of the vertices.

4. The system of claim 3, further including a module associated with the first pipeline to calculate distance ratios alpha and beta,
wherein alpha=Dout/(Din−Dout);
wherein Dout is the distance from one vertex to the clipping plane and Din is the distance from an adjacent vertex to the clipping plane; and
wherein beta=1−alpha.

5. The system of claim 4, further including a module associated with the first pipeline to assign new barycentric values to points that lie at an intersection of the determined clipping plane and the polygon.

6. The system of claim 5, further including a module associated with the first pipeline to assign new values to points that lie at the intersection of the determined clipping plane and the polygon.

7. A method of processing at least one graphics polygon, comprising:
determining a number of clipping planes against which a polygon is to be clipped; and
submitting, if there is only a single clipping plane, the polygon to a pipeline dedicated to single plane clipping.

8. The method of claim 7, further including:
loading coordinates of vertices of the polygon; and
assigning barycentric values to the coordinates of the vertices.

9. The method of claim 8, further including calculating a distance of the single clipping plane to each of the vertices.

10. The method of claim 9, further including calculating distance ratios alpha and beta,
wherein alpha=Dout/(Din−Dout);
wherein Dout is the distance from one vertex to the clipping plane and Din is the distance from an adjacent vertex to the clipping plane; and
wherein beta=1−alpha.

11. The method of claim 10, further including normalizing the distance between adjacent vertices.

12. The method of claim 11, further including assigning new barycentric values to points that lie at an intersection of the determined clipping plane and the polygon.

13. The method of claim 11, further including assigning new values to points that lie at an intersection of the determined clipping plane and the polygon.

14. The method of claim 7, wherein the polygon is a triangle.

15. The method of claim 7, further including submitting, if there is more than one clipping plane, the polygon to a second pipeline dedicated to multi-plane clipping.

16. An apparatus to process at least one graphics polygon, comprising:
a module that determines a number of clipping planes against which a polygon is to be clipped; and
a pipeline dedicated to single plane clipping.

17. The apparatus of claim 16, further including a module to:
load coordinates of vertices of the polygon; and
assign barycentric values to the coordinates of the vertices.

18. The apparatus of claim 17, further including a module to calculate a distance of a single clipping plane to each of the vertices.

19. The apparatus of claim 18, further including a module to calculate distance ratios alpha and beta,
wherein alpha=Dout/(Din−Dout);
wherein Dout is the distance from one vertex to the clipping plane and Din is the distance from an adjacent vertex to the clipping plane; and
wherein beta=1−alpha.

20. The apparatus of claim 18, further including a module to normalize the distance between adjacent vertices.

21. The apparatus of claim 19, further including a module to assign new barycentric values to points that lie at an intersection of the determined clipping plane and the polygon.

22. The apparatus of claim 21, further including a module to assign new values to points that lie at the intersection of the determined clipping plane and the polygon.

23. The apparatus of claim 17, wherein the polygon is a triangle.

24. The apparatus of claim 17, further comprising a second pipeline to handle cases in which there is more than one clipping plane.

25. The apparatus of claim 24, wherein the modules are available to both pipelines.
